(19) United States
(12) Patent Application Publication
(10) Pub. No.: US 2016/0132904 A1
(43) Pub. Date: May 12, 2016

(54) INFLUENCE SCORE OF A BRAND

(71) Applicant: HEWLETT-PACKARD DEVELOPMENT COMPANY, L.P., Houston, TX (US)

(72) Inventors: Arindam Mondal, Bangalore (IN); Bibhash Chakrabarty, Bangalore (IN); Silvia Daniel, Bangalore (IN)

(21) Appl. No.: 14/893,625

(22) PCT Filed: May 31, 2013
(86) PCT No.: PCT/US2013/043520

§ 371 Date: Nov. 24, 2015

(51) Int. Cl. G06Q 30/02; G06Q 50/00

(52) U.S. Cl. CPC G06Q 30/0201; G06Q 50/01

(57) ABSTRACT

An example method for determining an influence score of a brand in accordance with aspects of the present disclosure includes receiving data regarding a plurality of social media profiles associated with a plurality of social media platforms based on relevancy to a plurality of keywords, identifying a first set of data received from a first social media platform and a second set of data received from a second social media platform, extracting, values from the first set of data for a first set of categories of metrics for each social media profile associated with the first social media platform, extracting values from the second set of data for a second set of categories of metrics for each social media profile associated with the first social media platform, assigning a weight to each metric, determining an influence score for each social media profile based on calculating a weighted sum of the extracted values for each social media profile, and determining an influence score for the brand for each social media profile based on the influence score for each social media profile.

### BACKGROUND

Social media is a source of valuable information that may be used to generate data about products or services, branding, competition, and industries. Social media technologies take on many different forms including magazines, Internet forums, weblogs, microblogging (e.g., Twitter®), wikis, social networks, podcasts, photographs or pictures, video, rating and social bookmarking. A brand image of a brand may be determined by conducting customer surveys or polls. Social media platforms including blogs can be extremely valuable to a brand owner because the users of the brand may utilize these tools online to provide customer survey or poll information that can define the brand image of the brand.

Social media platforms may allow users to create profiles. Using these profiles, users may send messages to each other or post content for all to see. For example, Twitter® is a social media platform that allows users to send messages consisting of 140 characters or less. These messages are often referred to as “tweets”. Messages from a given Twitter profile may be seen by users that have chosen to subscribe to that profile's feed. Another example for a social media platform is Blogger®, which allows users to create blog posts under assigned blog domains. Many other social media platforms exist as well, such as Facebook®, Google+®, LinkedIn®.

### BRIEF DESCRIPTION OF THE DRAWINGS

Example implementations are described in the following detailed description and in reference to the drawings, in which:

FIG. 1 illustrates an example system to determine an influence score of a brand in accordance with an implementation;

FIG. 2 illustrates an example computer-readable medium to determine an influence score of a brand in accordance with an implementation; and

FIG. 3 illustrates an example process flow diagram in accordance with an implementation.

### DETAILED DESCRIPTION

Various implementations described herein are directed to influence scores of brands on a plurality of platforms over a given time period. More specifically, and as described in greater detail below, various aspects of the present disclosure are directed to a manner by which influence scores for brands in a defined topic during a specific time period are quantified.

Aspects of the present disclosure described herein extract brand mentions from the data received from various social media sources, such as microblogging sites and blog domains. Moreover, the aspects of the present disclosure described herein distribute influence scores in the proportions of the brand mentions. Accordingly, the approach described herein allows a brand owner to identify and engage with strong influencers on these social media platforms including microblogging sites and blog domains, which are beneficial to the business.

Moreover, aspects of the present disclosure described herein also extract values from the data received from a plurality of social media platforms based on a plurality of metrics. Among other things, this approach may prevent the brand owner from solely relying on customer surveys or polls filled out by brand users, and but still, interpret and measure seamlessly mass opinions generated by the brand users across a plurality of platforms, and understand both positive and negative influences towards purchase decisions and brand perception.

In one example in accordance with the present disclosure, a method for determining an influence score of a brand is provided. The method comprises receiving data regarding a plurality of social media profiles associated with a plurality of social media platforms based on relevancy to a plurality of keywords, identifying a first set of data received from a first social media platform and a second set of data received from a second social media platform, extracting, values from the first set of data for a first set of categories of metrics for each social media profile associated with the first social media platform, extracting values from the second set of data for a second set of categories of metrics for each social media profile associated with the first social media platform, assigning a weight to each metric, determining an influence score for each social media profile based on calculating a weighted sum of the extracted values for each social media profile, and determining an influence score for the brand for each social media profile based on the influence score for each social media profile.

In a further example in accordance with the present disclosure, a system is provided. The system comprises an interface to initiate a search of twitter profiles and blog domains based on a group of keywords and a time period, a communication interface to receive a list of twitter profiles and blog domains and associated data relevant to the keywords and the time period, and a metric extractor to identify values of content metrics, profile metrics, and network metrics for each twitter profile in the list of twitter profile. The metric extractor also identifies values of social engagement metrics, page influence metrics, domain influence metrics and activity metrics in the list of blog domains. Moreover, the system comprises a normalizer to normalize the values of all the metrics. Further, the system comprises a score determiner to determine an influence score for each twitter profile based on calculating a weighted average of the normalized values associated with each twitter profile. The score determiner also determines an influence score for each blog domain based on calculating a weighted sum of the normalized values associated with each blog domain. Further, the score determiner determines an influence score for the brand based on the influence score for each twitter profile and the influence score for each blog domain.

In another example in accordance with the present disclosure, a non-transitory computer-readable medium is provided. The non-transitory computer-readable medium comprises instructions that when executed cause a device to (i) receive data regarding a plurality of social media profiles associated with a plurality of social media platforms based on relevancy to a plurality of keywords, (ii) identify a first set of data received from a first social media platform and a second set of data received from a second social media platform, (iii) extract values from the first set of data for a first set of categories of metrics for each social media profile associated with the first social media platform, (iv) extract values from the second set of data for a second set of categories of metrics for each social media profile associated with the first social media platform, (v) assign a weight to each metric, (vi) determine an influence score for each social media profile based on calculating a weighted sum of the extracted values for each social media profile, and (vii) determine an influence score for the brand for each social media profile based on the influence score for each social media profile.

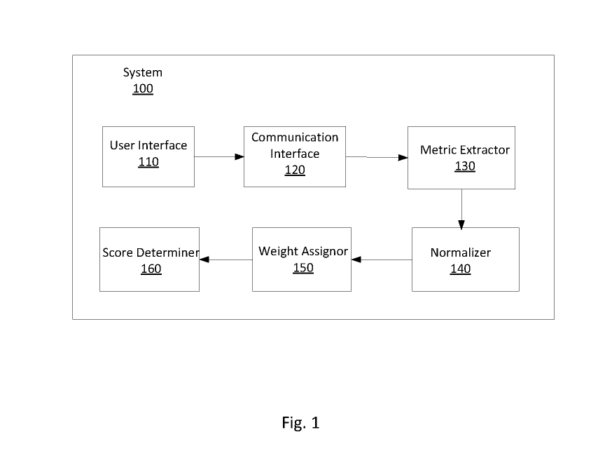

FIG. 1 illustrates an example system 100 in accordance with an implementation. The system 100 comprises a computer system to determine an influence score for a brand, according to one example. The system 100 may comprise a user interface 110, a communication interface 120, a metric extractor 130, a normalizer 140, a weight assignor 150, and a score determiner 160, each of which is described in greater detail below. The system 100 can be any of various computers or computing devices. For example, the system 100 can be a desktop computer, workstation computer, server computer, laptop computer, tablet computer, smart phone, or the like. It should be readily apparent that the system 100 depicted in FIG. 1 represents a generalized illustration and that other components may be added or existing components may be removed, modified, or rearranged without departing from a scope of the present disclosure. For example, while the system 100 illustrated in FIG. 1 includes only one computer, the system may actually comprise a plurality of computers, and only one has been shown and described for simplicity.

It should be noted that the system 100 is intended to be representative of a broad category of data processors. The system 100 may include a processor and memory and help translate input received by, for example, a keyboard. In one implementation, the system 100 may include any type of processor, memory or display. Additionally, the elements of the system 100 may communicate via a bus, network or other wired or wireless interconnection.

In some implementations, a user may interact with the system 100 by controlling a keyboard, which may be an input device for the system 100. The user may perform various gestures (e.g., touching, pressing) on the keyboard.

The system 100 can be used to search social media profiles (e.g., twitter profile, blog domain) based on one or more keywords. The social media profiles may be profiles of users associated with a social media platform. Moreover, the social media profiles may include domains of social media sites (e.g., blog) consisting of discrete entries by at least one author or content provider. A keyword can be received via the user interface 110. In one implementation, the user interface 110 may be a display of the system 100. The user interface 110 can include hardware components and software components. For example, the user interface 110 may include an input component, such as a keyboard, mouse, or touch-sensitive surface, etc., and an output component, such as a display, speakers, etc. The user interface 110 may refer to the graphical, textual and auditory information a computer program may present to the user, and the control sequences (such as keystrokes with the computer keyboard) the user may employ to control the program. In one example system, the user interface 110 may present various pages that represent applications available to the user. The user interface 110 may facilitate interactions between the user and computer systems by inviting and responding to user input and translating tasks and results to a language or image that the user can understand. In another embodiment, the system 100 may receive input from a plurality of input devices, such as a keyboard, mouse, touch device or verbal command.

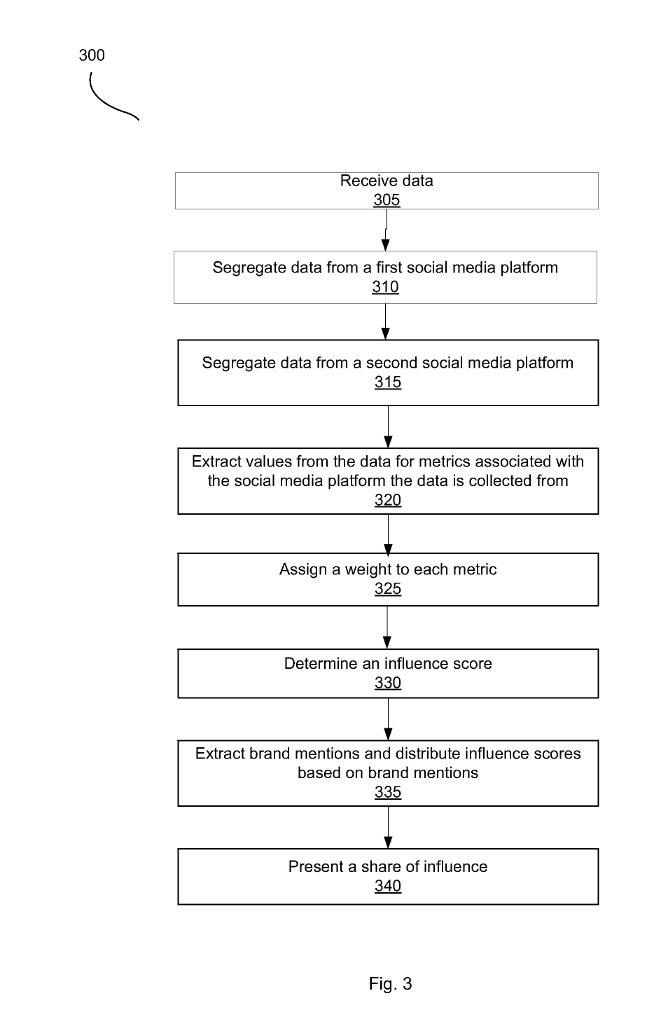

The user interface 110 may be resident on the device or system executing the methods disclosed herein or it can be on a remote computer, such as on a client device connecting to a server. The user interface 110 may initiate a search of social media profiles, such as twitter profiles and blog profiles, based on a keyword and/or a time period. The user may provide a set of keywords through the user interface 110. The keywords can relate to a topic, business context, or the like, as described above. The keyword can be provided to a monitoring engine. The monitoring engine can be resident on the device or system executing methods described herein or it can be hosted on another computer. In one example, the monitoring engine may be a third party system, such as Radian6. The engine may execute a search of the specified platforms and obtain data regarding social media profiles (e.g., a blog domain, twitter profile) that are relevant to the keyword. Accordingly, this data can be received. This data may be segregated based on the source. For example, the data captured from Twitter® may be segregated from the data captured from Blogger®. This data can then be used in a process, such as depicted in FIG. 3, to determine a plurality of scores, such as an influence score of the identified social media profiles, an influence score of the identified brands. Additional data regarding the profiles that is not provided by the social media monitoring engine may be obtained from the social media platform itself. For example, an application programming interface (API) for the social media platform may be used to request the data. The data may collected by forming Boolean search queries which would match the keywords related to a particular topic.

The communication interface 120 can be used to transmit and receive data to and from other computers. For example, the communication interface 120 may receive a list of social media profiles and associated data relevant to the keyword and/or time period. The communication interface 120 may include an Ethernet connection or other direct connection to a network, such as an intranet or the Internet. The communication interface 120 may also include, for example, a transmitter that may convert electronic signals to radio frequency (RF) signals and/or a receiver that may convert RF signals to electronic signals. Alternatively, the communication interface 120 may include a transceiver to perform functions of both the transmitter and receiver. The communication interface 120 may further include or connect to an antenna assembly to transmit and receive the RF signals over the air. The communication interface 120 may communicate with a network, such as a wireless network, a cellular network, a local area network, a wide area network, a telephone network, an intranet, the Internet, or a combination thereof.

The system 100 may include the metric extractor 130, the normalizer 140, the weight assignor 150, and the score determiner 160. These components may be implemented using a combination of hardware, software, firmware, or the like, including a machine readable medium storing machine-executable instructions and a processor or controller. The metric extractor 130 may identify values of content metrics, profile metrics, and network metrics for each social media profile. The metrics are described in greater detail below.

In one implementation, values may be extracted from the data for each social media profile. For example, values may be extracted from the data for a Twitter® profile. Further, values may be extracted from the data for a blog domain. The values may vary based on the source the data is collected from. The values may relate to a plurality of categories of metrics. For example, the metrics for data from a twitter profile may be different from the metrics for data collected from a blog domain.

More specifically, the values extracted from the data for a social media platform like twitter profiles may relate to a first, second, and third category of metrics. The first category of metrics may relate to messages associated with the social media profile. The second category of metrics may relate to attributes of each social media profile. The third category of metrics may relate to network relationships between each social media profile.

Example metrics for each category are described below with reference to a twitter profile. The author” referred to below is the user associated with the twitter profile (or owner of the twitter profile). Followers are those users that subscribe to the message feed of the author. Messages sent by the author appear in the timeline of each follower's account. An @mention is a type of message that explicitly mentions another twitter author in a tweet. This sends a notification to the mentioned author as well as causes the @mention to be visible on the author's message feed, which thus makes it viewable by the author's followers on their timelines. Retweets are a message from an author in which the author sends another author's tweet. Hash tags are a technique of categorizing a tweet by placing a hash tag (i.e., #) before the topic word. Thus, if an author wrote a tweet relating to cloud computing, the author could put a hash tag in front of the search term “cloud” as follows: “#cloud”. This enables other users to more accurately search for tweets relevant to a certain topic. Other metrics beyond those shown below may be used as well. Additionally, as mentioned above, some of the metrics may change if a different social media platform were used, such as Facebook®.

The first category of metrics may relate to on-topic tweets associated with a twitter profile. In one example, this category can be divided up into five basic measures: engagement gained, engagement done, on-topic activity, on-topic reach, and content value. Example metrics are described below with respect to each measure.

In one implementation, the engagement gained may comprise: (i) @mentions gained, which may be the count of tweets that mentions the author; (ii) @mentions gained—Unique authors, which may be the number unique profiles authoring tweets that mention the author; (iii) Retweets gained, which may be the number of retweets gained by the author; (iv) Retweets gained—Unique authors, which may be the number of unique profiles retweeting an author's tweets; (v) Unique tweets retweeted, which may be the number of unique tweets of the author that were retweeted; (vi) Retweets h-index, which may indicate that if an author has at least x tweets, each of which is retweeted at least x times, the highest possible value of x is the retweets h-index; (vii) Favorites gained, which may be the number of times tweets of the author were “favorited” (indicated as a favorite) by other users.

In one implementation, the engagement done may comprise: (i) @mentions done, which may be the number of tweets by the author containing an @mention; (ii) @mentions done—Unique authors, which may be the number of unique profiles mentioned by the author; (iii) Retweets done, which may be the number of retweets done by the author; (iv) Retweets done—Unique authors, which may be the number of unique profiles whose′ tweets were retweeted by the author. In a further implementation, the on-topic activity may comprise: (i) On-topic tweets, which may be the total count of on-topic tweets; (ii) Number of active days, which may be the number of days the author tweeted on the topic; (iii) Topic focus percentage, which may be the proportion of total tweets by the author that were ontopic. In some implementations, the on-topic reach may comprise: (i) Direct impressions, which may be the number of users on whose timeline the tweet is directly placed (based on the number of followers of the author); (ii) Derived impressions, which may be the number of users on whose timeline the tweet is indirectly placed, such as via retweets and @mentions. In other implementation, the content value may comprise: (i) Tweets with URL: The number of tweets containing a URL (Uniform Resource Locator); (ii) Tweets with hashtags: The number of tweets containing hash tags.

The second category of metrics may include profile information associated with the twitter profile. In one implementation, the profile URL declared may be used to determine whether a URL is associated with the profile. A profile URL may be a URL that points to a webpage associated with the author. For example, the webpage may be the author's personal homepage, a website for the author's business, etc. This metric may take the value of 1 if a profile URL is declared and 0 if not.

In another implementation, following may be the number of people that the author is following. In a further implementation, followers may be the number of people that are following the author. In some implementations, lists—member may be the number of lists that the author is a member of. A list in Twitter® may be created by any user and may include a list of twitter profiles associated with a particular topic or context. The presence of the author on multiple lists may indicate popularity and influence of the author. In other implementations, lists—Subscribed may be the number of lists that the author is subscribed to. By being subscribed to a list, the subscriber may receive tweets from the members of the list. In another implementation, updates done may be the total number of tweets sent from the profile over the life of the profile.

The third category of metrics may include network information related to the twitter profile. The relevant network may be smaller than the entire twitter network. For example, the network may relate only to twitter profiles connected to the given twitter profile in accordance with some degree of closeness. For example, followers, @mentions, and retweets may be considered when determining the network associated with a twitter profile. Example metrics are described below. These metrics may be based on graph theory related to discrete mathematics, where each twitter profile may represent a node in the network. In one example, a tool called NodeXL, which is an add-on tool for Microsoft Excel, may be used to compute the network metrics.

In one implementation, a metric may comprise betweenness centrality, which indicates whether a particular twitter profile is essential for some other nodes to maintain a relation to the network. In other words, it may indicate how many other profiles are connected solely through the given twitter profile. In another implementation, another metric may be closeness centrality, which indicates the average geodesic distance to other profiles. The geodesic distance is the shortest line between two points. Thus, this metric may indicate how close a given twitter profile is to other profiles. In a further implementation, another metric, eigenvector centrality may indicate a level of popularity of twitter profiles to which the given twitter profile is directly connected. In other words, it may indicate whether profiles that the given profile is adjacent to are adjacent to a large number of other profiles.

In some implementations, another metric may be clustering coefficient: This metric may indicate a level of connectedness and clustering among profiles in a given twitter profile's network. For example, this metric may indicate whether a given profile's connected profiles are also connected to each other, thus making a cluster of connections. This may indicate how tight-knit a profile's network is.

Any combination of metrics as described above, or others not illustrated, may be used to measure social influence of a given twitter profile. The values for each metric may be extracted from the data according to various techniques. For example, the data may be in the form of a spreadsheet, exported from a social media monitoring engine (e.g., Radian6). Values for each metric may thus be determined by referring to the appropriate field(s) in the spreadsheet. For instance, a macro may be programmed in Microsoft Excel to generate metric values for each twitter profile based on the spreadsheet data. As mentioned previously, the macro could leverage a tool such as NodeXL to generate the network graph and extract the network metric values. The values for some metrics may also be extracted using the API of the social media platform.

Similarly, a series of metrics may be extracted for social media platforms such as blog domains. In one embodiment, the values extracted from the data for blog domains may relate to four categories of metrics. The first category of metrics may relate to social engagement. The second category of metrics may relate to activities of each blog domain. The third category of metrics may relate to blog page influence, and the fourth category may relate to blog domain influence.

In one implementation, one category may involve social engagement. The social engagement may comprise a plurality of metrics. The metrics may comprise Facebook shares, Facebook comments, Facebook likes, LinkedIn shares, Twitter shares, Reddit Score. Another category may involve a group of metrics involving measuring the activity done on a blog domain. Example metrics may include: (i) consistency, which may be the count of the number of weeks in a given time frame the blog domain had a post; (ii) volume, which may be the count of post in a blog domain; (iii) recency, which may be the count of the number of days since the last blog post happened.

In another implementation, the next category may involve page influence. This category may measure how popular the blog post page in terms of its importance in the web, and, how others are influenced by the page. This category may comprise the following metric: (i) external links, which may be the count of pages from other web-pages that link to the concerned blog-post page; (ii) Page Authority, which may be measured as the predictive rank of the page in terms of its importance as compared to all the pages in the entire web; (iii) Page Mozrank, which is a measure of how many pages possessing good quality in the web link to the concerned blog post page.

The next group of metrics involves domain influence, which includes metrics to determine the influence on a domain level. Example metrics may comprise (i) unique visitors, (ii) total visits, (iii) average stay, which is the average time spent by a visitor on the blog domain (iv) sub domain mozrank, which measures the static importance of any webpage independent of any search query or links at the sub-domain level, (v) domain authority, which is measured as the predictive rank of the domain in terms of its importance as compared to other domains in the entire web.

In one implementation, the metrics may be mined for the blog from some search engine data API's and traffic data collection API's and some Excel macros may be used to combine them at a domain level.

The normalizer 140 may normalize the values of the content metrics, profile metrics, and network metrics. The normalizer 140 may normalize the values according to various techniques. In one implementation, a method where a MaxCutoff value and minimum value can be determined for each metric (over all of the social media profiles and domains) may be used. The MaxCutoff value can be a value in a certain high percentile of all of the values for a given metric. For instance, the MaxCutoff value can be the maximum value (the 100th percentile), a value in the 98th percentile, or the like. It can be helpful to use a percentile lower than the 100th percentile to exclude outlying values. The intermediate normalized value of a given extracted value may be determined by subtracting the minimum value from the value, and dividing the result by the result of subtracting the minimum value from the MaxCutoff value. The normalized value can be determined by multiplying the intermediate normalized value by 10. In some examples, the normalized values can be subject to a maximum value of ten, such that anything higher is changed to ten. Thus, the score can range between zero and ten, for example.

The weight assignor 150 may assign a weight to each metric. The weight may represent a relative importance of the metric to the overall influence score. The weight may be determined based on research and analysis of the market and the data platform. For instance, the particular business segment, context, or topic being considered may influence the importance of certain metrics. Similarly, the nature of the data platform may influence the importance of certain metrics. The weight may also be determined using a statistical technique, such as Structural Equation Modeling. Additionally, the weight may be determined by a user and set using a user interface. In such a case, assigning the weight to each metric may merely involve applying the predetermined weight to the metric. In one example, the weights may be set using a user interface or using an automated technique, such as via machine readable instructions employing Structural Equation Modeling.

Structural Equation Modeling is a technique that can estimate causal relations using a combination of statistical data and certain assumptions. A metric category may be considered a latent variable if it is not possible to measure it directly, for example, because it is hypothetical or unobserved. A combination of metrics may be used to determine the representative latent variable. The technique may be based on the hypothesis that a representative latent variable (e.g., Engagement done) may be explained by a linear combination of variables. For example, “Engagement done” may be modeled as a linear combination of four variables: @mentions done, @mentions done—Unique authors, Retweets done, and Retweets done—Unique authors. The weights or coefficients for each variable can be determined based on statistical importance and fulfillment of certain criterions for the model. The model created by this linear equation structure may be used for multi-level allocation of weights for each metric. For example, categorical weights may be determined for a group of metrics. For instance, a categorical weight may be determined for a category of “Engagement done” which can include the four metrics indicated above. Accuracy of the model can be improved with a large input data set (e.g., multiple profiles and associated data) that is free from missing values. In one example, a software tool or procedure may be used to perform the structural equation modeling, such as PROC CALIS in Statistical Analysis System (SAS).

As mentioned above, the weight for each metric may be determined and assigned using various techniques. One method may be that a user can set a weight for a metric using the user interface 110. As discussed earlier in greater detail, the user interface 110 can be a graphical user interface. The user interface 110 can be resident on the same computing device or system that executes methods disclosed herein or it can be resident on a different computing device or system. The user interface 110 can be part of an application, such as a main application that implements methods disclosed herein or a client application that interface with the main application. The user interface 110 can also be implemented via a web browser. The user may be an administrator of the system and may set the weights using the same computer system. Alternatively, in another implementation, the user may be a user implementing the system remotely from another device. The weight set via the user interface 110 can be assigned to the appropriate metric. Assigning the weight to a metric can include storing an association between the weight and the metric. For instance, assigning the weight can be accomplished by modifying a variable in memory.

The score determiner 160 may determine an influence score for each social media profile and domain. The influence score may be determined by calculating a weighted sum of the normalized values associated with each social media profile and domain. The weighted average may be determined using the weights assigned to each metric. The system 100 may store weights in association with the various metrics for calculating the weighted sum.

In addition or alternatively, the score determiner 160 may determine an influence score of a brand for each profile and domain. Each profile and domain's influence score for a brand may be calculated by multiplying the influence score for each profile and domain with the number of mentions of a brand proportion, which is the number of times a brand is mentioned out of all the mentions by that social media profile or blog domain. Further, the brand influence score may be calculated by summing the brand score for multiple profiles and domains. For example, influence scores associated with a brand for a plurality of twitter profiles and blog domains may be summed to determine the brand influence score.

Moreover, a share of influence may be calculated. The share of influence of a brand, which is the brand influence of a brand relative to the competition, may be expressed as a percentage.

In another implementation, the above mentioned scores may be calculated based on a sentiment analysis. For example, the influence score of a brand may be calculated based on a positive brand proportion. More specifically, the brand proportion may be limited to the ratio of the number of times a brand is mentioned in a positive context to all the positive mentions. Similarly, in another example, the influence score of the brand may be calculated based on a negative brand proportion. In such example, the brand proportion may be limited to the ratio of the number of times the brand is mentioned in a negative context to all the negative mentions. In a further example, the influence score of the brand may be calculated based on a neutral brand proportion. n such example, the brand proportion may be limited to the ratio of the number of times the brand is mentioned in a neutral context to all the neutral mentions.

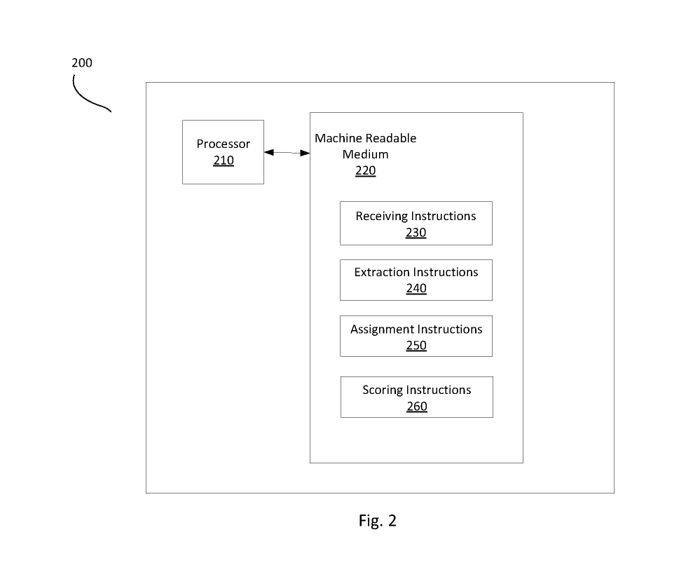

FIG. 2 illustrates a block diagram illustrating aspects of a computer 200 in accordance with an implementation. It should be readily apparent that the computer 200 illustrated in FIG. 2 represents a generalized depiction and that other components may be added or existing components may be removed, modified, or rearranged without departing from a scope of the present disclosure. The computer 200 comprises a processor 210, a machine readable medium 220 encoded with instructions, each of which is described in greater detail below. The components of the computer may be connected via buses. The computer 200 may be any of a variety of computing devices, such as a workstation computer, a desktop computer, a laptop computer, a tablet or slate computer, a server computer, or a smart phone, among others.

The processor 210 may retrieve and execute instructions stored in the machine readable medium 220. The processor 210 may be, for example, a central processing unit (CPU), a semiconductor-based microprocessor, an application specific integrated circuit (ASIC), a field-programmable gate array (FPGA) configured to retrieve and execute instructions, other electronic circuitry suitable for the retrieval and execution instructions stored on a computer readable storage medium, or a combination thereof. The processor 210 may fetch, decode, and execute instructions stored on the machine readable medium 220 to operate the computer 200 in accordance with the above-described examples. The machine readable medium 220 may be a non-transitory computer-readable medium that stores machine readable instructions, codes, data, and/or other information. The instructions, when executed by processor 210 (e.g., via one processing element or multiple processing elements of the processor) can cause processor 210 to perform processes described herein.

In certain implementations, the machine readable medium 220 may be integrated with the processor 210, while in other implementations, the machine readable medium 220 and the processor 210 may be discrete units.

Further, the computer readable medium 220 may participate in providing instructions to the processor 210 for execution. The machine readable medium 220 may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices.

In one implementation, the machine readable medium 220 may have a profile database. The database may store profile data such as authentication data, user interface data, and profile management data and/or the like.

In another implementation, the machine readable medium 220 may have weight and score databases. These databases may store data such as weight values assigned to different metrics and influence scores determined for social media profiles and blog domains and/or the like.

As discussed in more detail above, the processor 210 may be in data communication with the machine readable medium 220, which may include a combination of temporary and/or permanent storage. The machine readable medium 220 may include program memory that includes all programs and software such as an operating system, user detection software component, and any other application software programs. The machine readable medium 220 may also include data memory that may include system settings, a record of user options and preferences, and any other data required by any element of the computer 200.

In one implementation, the machine readable storage medium (media) may have instructions stored thereon/in which can be used to program the computer 200 to perform any of the processes of the embodiments described herein. Receiving instructions 230 can cause the processor 210 to receive data regarding multiple social media profiles and domains based on relevancy to a topic. The topic can include one or more keywords and can relate to a business context. The extraction instructions 240 can cause the processor 210 to extract values from the data for all metrics discussed in greater detail above for each profile and domain. Weight assignment instructions 250 can cause the processor 210 to apply a weight to each metric based on a categorical weight associated with each category of metrics and an individual weight associated with each metric within each category (e.g., three categories for social media profiles and four categories for social media domains). Accordingly, a categorical weight can be applied to each of categories of metrics, each of the categorical weights adding up to hundred percent. An individual weight may also be applied to each individual metric within the categories. Thus, a relative weight can be assigned to each general category indicating an overall value judgment on the importance of that category toward the influence score. The individual weights for each metric within the categories may thus be assigned relative to the other metrics within that category. Additionally, there can multiple categories at different levels. Overall, using categorical weights in addition to individual weights can provide an easier and more intuitive weighting assignment process than assigning a single weight to all of the metrics. Similarly, the previously described weighting process can be applied to computer 200 instead of this one.

Scoring instructions 260 can cause the processor 210 to determine an influence score for each profile and domain based on calculating a weighted average of the values for each profile. The weighted average can be calculated based on the weights applied by the weighed assignment instructions 250. For example, a weighted average can be determined for each category of metrics based on the individual weights on the individual metric values. The overall weighted average can then be determined by calculating a weighted average of the weighted averages of each category using the categorical weights. The influence score can thus be based on that overall weighted average. Alternatively, an overall weight for each individual metric can be determined used the respective categorical weight and individual weight, and the weighted average can be determined using the overall weight for each metric.

Further, the scoring instructions can cause the processor 210 to determine an influence score of a brand for each profile and domain based on the influence score of each profile and domain. Moreover, the overall brand influence score may be calculated by aggregating all the influence scores of the brand from all the profiles and domains. Further, the scoring instructions can cause the processor 210 to determine a share of influence of the brand relative to the brand's competitors, which may be expressed in a percentage.

Turning now to the operation of the system 100, FIG. 3 illustrates an example process flow diagram 300 in accordance with an implementation. It should be readily apparent that the processes illustrated in FIG. 3 represents generalized illustrations, and that other processes may be added or existing processes may be removed, modified, or rearranged without departing from the scope and spirit of the present disclosure. Further, it should be understood that the processes may represent executable instructions stored on memory that may cause a processor to respond, to perform actions, to change states, and/or to make decisions. Thus, the described processes may be implemented as executable instructions and/or operations provided by a memory associated with the systems 100 and 200. Alternatively or in addition, the processes may represent functions and/or actions performed by functionally equivalent circuits like an analog circuit, a digital signal processor circuit, an application specific integrated circuit (ASIC), or other logic devices associated with the systems 100 and 200. Furthermore, FIG. 3 is not intended to limit the implementation of the described implementations, but rather the figure illustrates functional information one skilled in the art could use to design/fabricate circuits, generate software, or use a combination of hardware and software to perform the illustrated processes.

The process illustrated in FIG. 3 can be implemented to determine an influence score of a brand. This process includes determining an influence score of one or more social media profiles. As discussed in more detail in reference to FIG. 1, the social media profiles may be profiles of users associated with a social media platform. The social media platform may enable the sharing of information, messages, photos, videos, or the like. For example, the social media platform may be Twitter®, Facebook®, Google+®, or LinkedIn®. Moreover, the social media profiles may comprise domains associated with users on a social media platform such as blogs which contains blog domains presenting discrete blog entries by users.

The process 300 may begin at block 305, where data regarding multiple social media profiles may be received. In particular, the data can be the result of a search of social media profiles and associated data from a social media platform, such as Twitter®, and blogs. As discussed above with reference to FIG. 1, a social media monitoring engine such as Radian6 may be used to perform the search. Additional data regarding the profiles that is not provided by the social media monitoring engine may be obtained from the social media platform and sites itself. For example, an application programming interface (API) for the social media platform may be used to request the data, such as the Twitter API.

The search can be performed based on one or more keywords or a combination of keywords and Boolean operators. The keywords can define or relate to a particular topic or business context. For example, a user, such as a business, may be interested in determining the brand influence in the topic area of music, in which case “music” may be a keyword. More specifically, the user may be interested in the brand influence in the topic area of country music, in which case “country music” may be a keyword. In another example, the user may be interested in the topic area/business context of security aspects of cloud computing, in which case “cloud AND security”, or the like may be the keyword combination. Additionally, the search can be performed based on a time period. For example, the search could be limited to on-topic messages or blog entries that were sent during the specified time period.

The data regarding the social media profiles may include various types of information depending on the type of social media platform that the social media profile is associated with. For example, for a twitter profile, the data may include information regarding the messages sent from the twitter profile, information related to the twitter profile, and information regarding the profile's network. Moreover, the content and type of data may be based on the nature of the social media platform that the profile comes from. Additionally, the content and type of data may depend on the type of social media monitoring engine used, as different engines may provide different data.

At block 310, data received from a first social media platform may be segregated. In one example, the first social media platform may be Twitter®. At block 315, data received from a second social media platform may be segregated. In one example, the second social media platform may be a blog and the data may be received from a blog domain built on the blog.

At block 320, values may be extracted from the data. The values may relate to a plurality of categories of metrics. As discussed in greater detail in reference to FIG. 1, the categories vary depending on the type of the social media platform the data is received from. More specifically, in case of Twitter®, the first category of metrics may relate to messages associated with the social media profile. The second category of metrics may relate to attributes of each social media profile. The third category of metrics may relate to network relationships between each social media profile. For a blog domain, the categories may be social engagement, activity, page influence and domain influence.

In one implementation, this process may further involve the system normalizing metric values. In particular, this process involves a MaxCutoff value and minimum value to be determined for each metric (over all of the social media profiles). The MaxCutoff value can be a value in a certain high percentile of all of the values for a given metric. For instance, the MaxCutoff value can be the maximum value (the 100th percentile), a value in the 98th percentile, or the like. It can be helpful to use a percentile lower than the 100th percentile to exclude outlying values. The intermediate normalized value of a given extracted value may be determined by subtracting the minimum value from the value, and dividing the result by the result of subtracting the minimum value from the MaxCutoff value. The normalized value can be determined by multiplying the intermediate normalized value by 10. In some examples, the normalized values can be subject to a maximum value of ten, such that anything higher is changed to ten. Thus, the score can range between zero and ten, for example.

At block 325, a weight is set for each metric. In one implementation, a user may set a weight for a metric using a user interface. The weight set via the user interface can be assigned to the appropriate metric. In particular, assigning the weight to a metric may include storing an association between the weight and the metric. For instance, assigning the weight may be accomplished by modifying a variable in memory.

At block 330, an influence score may be determined for each social media profile. The score may be determined by calculating a weighted sum of the metric values for each profile. The weighted sum may be determined using the weights assigned at block 325. Accordingly, an influence score directed to the particular topic or business context originally searched may be determined for multiple social media profiles on a social media platform.

At block 335, a brand influence score may be determined based on the influence score of each social media profile. In particular, this process may involve extracting mentions related to the brand and calculating a brand proportion by determining a ratio between the number of brand mentions and the total number of mentions. Further, this process may also involve summing all the brand influence scores for each social media profile. In one implementation, this process may be performed based on a sentiment analysis. For example, the mentions considered may be limited to positive mentions, negative mentions or neutral mentions.

At block 340, a share of influence for the brand is illustrated. In particular, this process may involve expressing the brand influence as a percentage relative to the scores associated with the brand's competitors. In one implementation, the client may identify and submit a list of competitor names. Alternatively, in another implementation, if the client does not identify any competitors, the system may retrieve a client profile and identify an industry, interested key terms of the client from its profile, and thus determine a set of competitors for the client.

The present disclosure has been shown and described with reference to the foregoing exemplary implementations. It is to be understood, however, that other forms, details, and examples may be made without departing from the spirit and scope of the disclosure that is defined in the following claims. As such, all examples are deemed to be non-limiting throughout this disclosure.

What is claimed is:

1. A method for determining an influence score of a brand, comprising:
receiving data regarding a plurality of social media profiles associated with a plurality of social media platforms based on relevancy to a plurality of keywords;
identifying, via a processor, a first set of data received from a first social media platform and a second set of data received from a second social media platform;
extracting, via the processor, values from the first set of data for a first set of categories of metrics for each social media profile associated with the first social media platform;
extracting, via the processor, values from the second set of data for a second set of categories of metrics for each social media profile associated with the second social media platform;
assigning, via the processor, a weight to each metric;
determining, via the processor, an influence score for each social media profile based on calculating a weighted average of the extracted values for each social media profile; and
determining, via the processor, an influence score for the brand of at least one social media profile based on the influence score for the at least one social media profile.

2. The method of claim 1, wherein determining the influence score for the brand for the at least one social media profile based on the influence score for the at least one social media profile further comprises:
extracting data related to the brand;
calculating a brand proportion for the brand based on the extracted data related to the brand; and
multiplying the brand proportion by the influence score for the social media profile.

3. The method of claim 1, further comprising determining a total influence score of the brand by summing the influence score of the brand for each social media profile.

4. The method of claim 1, further comprising determining a share of influence for the brand based on a comparison of the total influence score of the brand with total brand influence scores of competitors of the brand.

5. The method of claim 4, wherein the share of influence is expressed as a percentage.

6. The method of claim 2, wherein the brand proportion of the brand corresponds to a ratio of mentions associated with the brand by each social media profile to all mentions by each social media profile.

7. The method of claim 2, wherein the brand proportion of the brand corresponds to a ratio of positive mentions associated with the brand by each social media profile to all positive mentions by each social media profile.

8. The method of claim 2, wherein the brand proportion of the brand corresponds to a ratio of negative mentions associated with the brand by each social media profile to all negative mentions by each social media profile.

9. The method of claim 1, wherein the first set of categories of metrics comprises a first category of metrics relating to messages associated with each social media profile, a second category of metrics relating to attributes of each social media profile, and a third category of metrics relating to network relationships between each social media profile.

10. The method of claim 1, wherein the second set of categories of metrics comprises a first category of metrics relating to social engagements between each social media profile on the second social media platform and other social media platforms, a second category of metrics relating to influential attributes of the second set of data, a third category of metrics relating to influential attributes of each social media profile on the second social media platform, the fourth category of metrics relating to activities done on the second social media platform;

11. The method of claim 1, wherein the first social media platform is Twitter®.

12. The method of claim 1, wherein the second social media platform is a blog domain.

13. The method of claim 1, further comprising:
identifying, via a processor, a third set of data received from a third social media platform; and
extracting, via the processor, values from the third set of data for a third set of categories of metrics for each social media profile associated with the third social media platform.

14. The method of claim 1, wherein the plurality of keywords defining a topic.

15. The method of claim 1, wherein the keyword relates to a business context and the data is associated with a time period.

16. The method of claim 1, further comprising normalizing each extracted value of each metric based on the following formula:
(Value−Min)*10/(Maxcutoff−Min),
wherein Value is an extracted value for a given metric for a given social media profile, Min is a minimum extracted value for the given metric based on all of the social media profiles, and MaxCutoff is a value in the 98th percentile for the given metric based on all of the social media profiles.

17. The method of claim 1, wherein the weight for a metric is determined using Structural Equation Modeling.

18. A system for determining an influence score for a brand, comprising:
an interface to initiate a search of twitter profiles and blog domains based on a keyword and a time period;
a communication interface to receive a list of twitter profiles and blog domains and associated data relevant to the keyword and the time period;
a metric extractor to:
identify values of content metrics, profile metrics, and network metrics for each twitter profile in the list of twitter profile, and
identify values of social engagement metrics, page influence metrics, domain influence metrics and activity metrics in the list of blog domains;
a normalizer to normalize the values of all the metrics; and
a score determiner to:
determine an influence score for each twitter profile based on calculating a weighted average of the normalized values associated with each twitter profile,
determine an influence score for each blog domain based on calculating a weighted sum of the normalized values associated with each blog domain, and
determine an influence score for the brand based on the influence score for each twitter profile and the influence score for each blog domain.

19. The system of claim 19, further comprising a database to store weights associated with the metrics, and wherein the score determiner is to use the stored weights to calculate the weighted average of the normalized values.

20. A non-transitory computer-readable medium comprising instructions that when executed cause a system to:
receive data regarding a plurality of social media profiles associated with a plurality of social media platforms based on relevancy to a plurality of keywords;
identify a first set of data received from a first social media platform and a second set of data received from a second social media platform;
extract values from the first set of data for a first set of categories of metrics for each social media profile associated with the first social media platform;
extract values from the second set of data for a second set of categories of metrics for each social media profile associated with the first social media platform;
assign a weight to each metric;
determine an influence score for each social media profile based on calculating a weighted average of the extracted values for each social media profile; and
determine an influence score for the brand for each social media profile based on the influence score for each social media profile.
